(19) United States
(12) Patent Application Publication
(10) Pub. No.: US 2026/0357038 A1
(43) Pub. Date: Nov. 12, 2026

(54) RUBBER COMPOSITION

(71) Applicant: COMPAGNIE GENERALE DES ETABLISSEMENTS MICHELIN, Clermont-Ferrand (FR)

(72) Inventors: MAXIME PRAS, Clermont-Ferrand (FR); JOSE-CARLOS ARAUJO DA SILVA, Clermont-Ferrand (FR); SEVERIN DRONET, Clermont-Ferrand (FR); FABIEN ROUDAUT, Clermont-Ferrand (FR)

(21) Appl. No.: 19/137,897

(22) PCT Filed: Dec. 5, 2023
(86) PCT No.: PCT/EP2023/084345

§ 371 Date: Jun. 11, 2025

(30) Foreign Application Priority Data
Dec. 15, 2022 (FR) FR2213424

(51) Int. Cl. C08K 3/36; B60C 1/00; C08F 236/06; C08K 3/06; C08K 3/22; C08K 5/09; C08K 5/18; C08K 5/31; C08K 5/372; C08K 5/47; C08K 5/521

(52) U.S. Cl. CPC C08K 3/36; B60C 1/0016; C08K 3/06; C08K 3/22; C08K 5/09; C08K 5/18; C08K 5/31; C08K 5/47; C08F 236/06; C08K 2003/2296; C08K 5/372; C08K 5/521

(57) ABSTRACT

A rubber composition comprises a reinforcing filler, a crosslinking system, an elastomer A, a random copolymer comprising monomer units of a 1,3-diene and monomer units of a C₄ alkyl methacrylate, the monomer units of the methacrylate representing at least 30 mol % of the monomer units of the elastomer A. The rubber composition enables an improvement in the reinforcement of treads consisting of the rubber composition.

The field of the present invention is that of rubber compositions reinforced by a reinforcing filler, especially used in the manufacture of tyres for vehicles.

One of the requirements for a tyre tread is to withstand wear and attacks from the ground over time. One way to impart it with good mechanical strength is to use a rubber composition exhibiting good reinforcement for the tyre tread. As is well known, a person skilled in the art can achieve this type of property by adding reinforcing fillers to the rubber composition.

However, at the same time, the tyre tread must also minimize its contribution to the rolling resistance of the tyre, that is to say have the lowest possible hysteresis. As is well known, a person skilled in the art can achieve this type of property by reducing the amount of reinforcing filler in the rubber composition constituting the tread.

Another requirement for a tyre tread is to provide optimal grip on the road, especially on wet ground. One way to achieve this is to use a rubber composition exhibiting a broad hysteresis potential for the tyre tread.

Thus, the rubber composition of the tread must satisfy potentially conflicting requirements, namely having a maximum reinforcement in order to satisfy the requirement for mechanical strength, having a hysteresis that is as low as possible in order to satisfy the requirement for rolling resistance, and having a high hysteresis in order to satisfy the requirement for grip on wet ground.

In order to improve the grip performance on wet ground of a tyre while retaining a good performance compromise with the rolling resistance, patent application WO 2016/001052 has proposed introducing elastomers comprising monomer units of an ester of methacrylic acid into the rubber compositions constituting the tyre treads.

The applicant, continuing research efforts, has discovered that the choice, as elastomer comprising monomer units of an ester of methacrylic acid, of an elastomer comprising monomer units of a 1,3-diene and monomer units of an ester of methacrylic acid type (in this case a methacrylate of an alkyl having 4 carbon atoms) makes it possible to obtain rubber compositions having a better reinforcement index.

Thus, a first subject of the invention is a rubber composition comprising:
a reinforcing filler,
a crosslinking system,
an elastomer A, a random copolymer comprising monomer units of a 1,3-diene and monomer units of an ester of methacrylic acid corresponding to the formula

CH₂═CMe-COOR¹
in which Me is a methyl group and R¹ is a C₄ alkyl group,
the monomer units of the methacrylic acid representing at least 30 mol % of the monomer units of the elastomer A.

Another subject of the invention is a semi-finished product, in particular a tread, comprising a rubber composition in accordance with the invention.

A subject of the invention is also a tyre comprising a rubber composition in accordance with the invention or a semi-finished product, preferentially a tread, which is in accordance with the invention. Such a tyre exhibits an improved compromise between the rolling resistance performance and the grip performance on wet ground, on the one hand, and good reinforcement on the other.

### DETAILED DESCRIPTION

Any range of values denoted by the expression “between a and b” represents the range of values extending from more than a to less than b (that is to say, limits a and b excluded), whereas any range of values denoted by the expression “from a to b” means the range of values extending from a up to b (that is to say, including the strict limits a and b).

All the percentages are percentages by mass, unless otherwise indicated.

The abbreviation “phr” means parts by weight per hundred parts of elastomers present in the elastomer matrix.

“Elastomer matrix” is understood to mean all the elastomers present in the rubber composition.

The compounds mentioned in the description (typically the polymers, the fillers, the plasticizers, the coupling agents, the vulcanization system, the other additives, etc.) may be of fossil origin or biobased.

In the latter case, they may be partially or completely derived from biomass or obtained from renewable raw materials derived from biomass. In the same way, the compounds mentioned may also originate from the recycling of already-used materials, i.e. they may partially or completely result from a recycling process, or else be obtained from raw materials which themselves result from a recycling process.

In the present patent application, a carbon chain is understood to mean a chain which contains one or more carbon atoms.

In the present patent application, Cₓ will denote a (saturated or unsaturated) carbon chain comprising x carbon atoms (x being an integer) and Cₓ-C_{y} will denote a (saturated or unsaturated) carbon chain comprising from x to y carbon atoms (y also being an integer). The designation Cₓ alkyl is used to refer to an alkyl consisting of a carbon chain having x carbon atoms. The designation Cₓ-C_{y} alkyl is used to refer to an alkyl consisting of a carbon chain having x to y carbon atoms.

The invention described in greater detail hereinafter relates to at least one of the subjects defined according to any one of the following listed embodiments:
1—Rubber composition comprising:
   a reinforcing filler,
   a crosslinking system,
   an elastomer A, a random copolymer comprising monomer units of a 1,3-diene and monomer units of an ester of methacrylic acid corresponding to the formula

CH₂═CMe-COOR¹
in which Me is a methyl group and R¹ is a C₄ alkyl group,
the monomer units of the ester of methacrylic acid representing at least 30 mol % of the monomer units of the elastomer A.
2—Rubber composition according to Embodiment 1, wherein R¹ is a linear alkyl group.
3—Rubber composition according to either of Embodiments 1 and 2, wherein the monomer units of the ester of methacrylic acid represent at least 40 mol % of the monomer units of the elastomer A.
4—Rubber composition according to any one of Embodiments 1 to 3, wherein the monomer units of the ester of methacrylic acid represent at most 90 mol %, preferentially at most 80 mol %, more preferentially at most 60 mol %, of the monomer units of the elastomer A.
5—Rubber composition according to any one of Embodiments 1 to 3, wherein the monomer units of the ester of methacrylic acid represent at most 60 mol % of the monomer units of the elastomer A.
6—Rubber composition according to any one of Embodiments 1 to 5, wherein the elastomer A is a copolymer of the 1,3-diene and the ester of methacrylic acid.
7—Rubber composition according to any one of Embodiments 1 to 6, wherein the 1,3-diene is 1,3-butadiene or isoprene or a mixture of 1,3-butadiene and isoprene, preferentially 1,3-butadiene.
8—Rubber composition according to any one of Embodiments 1 to 7, wherein the reinforcing filler comprises a silica.
9—Rubber composition according to Embodiment 8, wherein the silica represents more than 50% by mass of the reinforcing filler, preferentially more than 80% by mass of the reinforcing filler.
10—Rubber composition according to any one of Embodiments 1 to 9, wherein the crosslinking system is a vulcanization system.
11—Semi-finished product comprising a composition according to any one of the preceding embodiments.
12—Semi-finished product according to Embodiment 11, characterized in that it is a tyre tread.
13—Tyre comprising a semi-finished product according to either of Embodiments 11 and 12 or a rubber composition according to any one of Embodiments 1 to 10.

An essential feature of the rubber composition of the invention is that it includes an elastomer A, a random copolymer comprising monomer units of a 1,3-diene and monomer units of an ester of methacrylic acid.

The ester of methacrylic acid the monomer units of which constitute the elastomer A corresponds to the following formula (I):

CH₂═CMe-COOR¹ (I)
in which Me is a methyl group and R¹ is a C₄ alkyl group.

Preferably, R¹ is a linear alkyl group, and R¹ is then n-butyl.

The monomer units of the ester of methacrylic acid represent at least 30 mol %, preferentially at least 40 mol %, of the monomer units of the elastomer A.

According to one embodiment of the invention, the monomer units of the ester of methacrylic acid represent at most 90 mol %, preferentially at most 80 mol %, and more preferentially at most 60 mol %, of the monomer units of the elastomer A.

These preferential ranges, which relate to the molar percentages of the monomer units of the ester of methacrylic acid in the elastomer A, may be applied to any one of the embodiments of the invention.

As 1,3-dienes the monomer units of which constitute the elastomer A, the following are suitable in particular: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene, or 2-methyl-3-isopropyl-1,3-butadiene, an aryl-1,3-butadiene, or 1,3-pentadiene. The 1,3-diene is preferably 1,3-butadiene, isoprene or a mixture of 1,3-butadiene and isoprene. More preferentially, the 1,3-diene is 1,3-butadiene.

The monomer units of the 1,3-diene constituting the elastomer A preferentially represent at least 10 mol % of the monomer units of the elastomer A.

According to one embodiment of the invention, the elastomer A is an elastomer obtained by radical polymerization, in particular in bulk, in solution or in a dispersed medium, especially in emulsion, dispersion or suspension. Radical polymerization, especially in bulk, in solution or in a dispersed medium, is a process well known to those skilled in the art of polymer synthesis. The choice of one or other of these three processes may be guided, for example, by the reactivity of the monomers to be polymerized, the polymerization kinetics or the exothermicity of the polymerization reaction. For the choice of the polymerization process, reference may, for example, be made to the following publications: Macromolecules, 1998, 31, 2822-2827; Macromolecules, 2006, 39, 923-930; J. Am. Chem. Soc. 1951, 73, 5736. This embodiment may be applied to any one of the embodiments of the invention.

According to a preferential embodiment of the invention, the elastomer A is a random copolymer of a 1,3-diene as defined above and an ester of methacrylic acid of formula (I). The elastomer A may then be obtained by radical polymerization of the 1,3-diene and the ester of methacrylic acid according to one of the processes mentioned above. According to this preferential embodiment, advantageously, the monomer units of the ester of methacrylic acid represent from 40 to 60 mol % of the monomer units of the elastomer A, and consequently the monomer units of the 1,3-diene represent from 40 to 60 mol % of the monomer units of the elastomer A.

The elastomer A itself may consist of a single elastomer or multiple elastomers that differ from each other by their composition or their macrostructure (in particular the distribution of molar masses of the polymer chains composing them).

The rubber composition may comprise, in addition to the elastomer A, other elastomers. Mention will in particular be made, as other elastomers that may be suitable, of the elastomers usually used in rubber compositions intended for the manufacture of tyres, such as polyisoprenes, polybutadienes, isoprene copolymers, and butadiene copolymers, such as copolymers of butadiene and styrene.

According to any one of the embodiments of the invention, the content of the elastomer A in the rubber composition is preferentially greater than 50 phr, more preferentially greater than 80 phr, and more preferentially still equal to 100 phr. When the elastomer A is used in a content of 100 phr, it is then the only elastomer present in the rubber composition.

These preferential variants of content of the elastomer A in the rubber composition may be applied to any one of the embodiments of the invention.

The rubber composition according to the invention comprises a reinforcing filler which, according to one embodiment of the invention, comprises a silica.

The silica (SiO₂) used may be any reinforcing silica known to those skilled in the art, in particular any precipitated or fumed silica. As examples of highly dispersible precipitated silicas (“HDSs”), mention will be made of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber or the silicas with a high specific surface area as described in patent application WO 03/016387.

The physical state in which the silica is provided is not important, whether this be in the form of a powder, of micropearls, of granules or else of beads.

According to one embodiment of the invention, the silica represents more than 50% by mass of the reinforcing filler: the silica is then the predominant reinforcing filler by mass. Preferentially, the silica represents more than 80% by mass of the reinforcing filler. These preferential ranges of proportion by mass of silica in the reinforcing filler may be applied to any one of the embodiments of the invention.

It will be noted that the reinforcing filler may contain, in addition to the silica, at least one other reinforcing filler which may be a reinforcing inorganic filler or a reinforcing organic filler.

The term “reinforcing inorganic filler” should be understood, in the present patent application, as meaning, by definition, any inorganic or mineral filler (whatever its colour and its origin (natural or synthetic)), also referred to as “white filler”, “clear filler”, or even “non-black filler”, in contrast to carbon black, capable of reinforcing, by itself alone, without means other than an intermediate coupling agent, a rubber composition intended for the manufacture of tyres, in other words capable of replacing, in its reinforcing role, a conventional tyre-grade carbon black; such a filler is generally characterized, in a known way, by the presence of hydroxyl (—OH) groups at its surface. Mention will also be made, as reinforcing inorganic filler other than the silica, of mineral fillers of the aluminous type, in particular alumina (Al₂O₃) or aluminium (oxide) hydroxides, or also of reinforcing titanium oxides, for example described in U.S. Pat. Nos. 6,610,261 and 6,747,087.

If the reinforcing filler contains a reinforcing organic filler, the reinforcing organic filler is preferentially a carbon black. This reinforcing organic filler, preferentially carbon black, is then preferentially present in a percentage by weight of less than 50%.

According to the particular embodiment in which the silica represents more than 50% by mass of the reinforcing filler, the carbon black is used preferably at a content of less than 20 phr, more preferentially less than 10 phr (for example between 0.5 and 20 phr, especially between 2 and 10 phr), more preferentially still less than 5 phr. Within the ranges indicated, the colouring (black pigmentation agent) and anti-UV properties of carbon blacks are exploited, without otherwise penalizing the typical performance provided by the reinforcing inorganic filler.

All carbon blacks, in particular the blacks conventionally used in tyres, are suitable as carbon blacks. Among the latter, mention will be made more particularly of the reinforcing carbon blacks of the 100, 200 and 300 series, or the blacks of the 500, 600 or 700 series (ASTM grades), such as for example the N115, N134, N234, N326, N330, N339, N347, N375, N550, N683 and N772 blacks. These carbon blacks may be used in isolation, as available commercially, or in any other form, for example as support for some of the rubber additives used.

Preferentially, the content of reinforcing filler in the rubber composition is between 40 and 200 phr. Below 40 phr, the reinforcement of the rubber composition might be insufficient to provide an adequate level of cohesion or wear resistance of the rubber composition. Above 200 phr, there is a risk of an increase in the hysteresis and thus in the rolling resistance of the tyres. More preferentially, the content of reinforcing filler in the rubber composition is between 60 and 140 phr. These preferential ranges of content of reinforcing filler may be applied to any one of the embodiments of the invention.

In the embodiments in which the reinforcing filler comprises a silica, and in particular in the case in which the silica constitutes more than 50% by weight of the reinforcing filler of the rubber composition, a coupling agent (or bonding agent) is typically used, as is well known, to couple the silica to at least one of the elastomers which constitute the elastomer matrix of the rubber composition.

As is well known, a coupling agent is an agent capable of establishing a sufficient bond of chemical and/or physical nature between the filler in question and the elastomer, while facilitating the dispersion of this filler within the elastomer matrix. This at least bifunctional agent is intended to ensure a sufficient connection, of chemical and/or physical nature, between the inorganic filler, in this case the silica, and the elastomer. Use is made, in particular, of organosilanes, especially alkoxysilane polysulfides or mercaptosilanes, or else polyorganosiloxanes bearing functions capable of bonding physically and/or chemically to the inorganic filler and functions capable of bonding physically and/or chemically to the elastomer, for example by means of a sulfur atom. Silica/elastomer bonding agents, especially, have been described in a large number of documents, the best known being bifunctional alkoxysilanes such as alkoxysilane polysulfides. Use is made in particular of silane polysulfides, referred to as “symmetrical” or “asymmetrical” depending on their specific structure, such as described for example in patent applications WO03/002648 (or US 2005/016651) and WO03/002649 (or US 2005/016650).

Mention will in particular be made, as coupling agent other than alkoxysilane polysulfide, of bifunctional POSs (polyorganosiloxanes), or else of hydroxysilane polysulfides as described in patent applications WO 02/30939 (or U.S. Pat. No. 6,774,255) and WO 02/31041 (or US 2004/051210), or else of silanes or POSs bearing azodicarbonyl functional groups, as described for example in patent applications WO 2006/125532, WO 2006/125533 and WO 2006/125534.

Also suitable as coupling agent are alkoxysilanes bearing an amine function, such as 3-aminopropyltrimethoxysilane, 3-aminopropyltriethoxysilane and 2-aminoethyltriethoxysilane, available for example from the suppliers Sigma-Aldrich, Gelest and Molport.

The content of coupling agent in the rubber composition according to the invention, whether this be a single compound or a mixture of compounds, is advantageously less than 20 phr, it being understood that it is generally desirable to use as little as possible thereof. Typically, the content of coupling agent represents from 0.5% to 15% by weight relative to the amount of silica. Its content is preferentially between 0.5 and 12 phr, more preferentially within a range extending from 3 to 10 phr. This content is easily adjusted by those skilled in the art according to the content of silica used in the composition, and the preferential ranges thereof are applicable to any one of the embodiments of the invention.

Another essential feature of the composition according to the invention is that it comprises a crosslinking system.

The crosslinking system may be based on sulfur, peroxides or mixtures thereof. In other words, the crosslinking may be based on reactions involving sulfur or peroxides or both. The content of the compound or compounds that constitute the crosslinking system introduced into the rubber composition is adjusted by those skilled in the art according to the targeted degree of crosslinking of the rubber composition and the chemical nature of the crosslinking system. This crosslinking level is defined by those skilled in the art according to the desired rigidity of the rubber composition in the crosslinked state, this rigidity varying depending on the envisaged application of the rubber composition.

The crosslinking system according to the invention is preferably a vulcanization system, that is to say a system based on sulfur (or on a sulfur-donating agent) and on a primary vulcanization accelerator.

Various known secondary vulcanization accelerators or vulcanization activators, such as zinc oxide, stearic acid or equivalent compounds, or guanidine derivatives (in particular diphenylguanidine), or else known vulcanization retarders, may be added to this base vulcanization system, being incorporated during the first non-productive phase and/or during the productive phase, as described subsequently. Mention may be made, as (primary or secondary) vulcanization accelerator, of any compound capable of acting as accelerator for the vulcanization of diene elastomers in the presence of sulfur, especially accelerators of the thiazole type, and also derivatives thereof, and accelerators of sulfenamide, thiuram, dithiocarbamate, dithiophosphate, thiourea and xanthate types. Sulfur is used at a preferential content of between 0.5 and 12 phr, in particular between 1 and 10 phr. The primary vulcanization accelerator is used in the rubber composition at a preferential content of between 0.5 and 10 phr, more preferentially of between 0.5 and 5.0 phr. These preferential ranges relating to the contents of sulfur and of accelerator may be applied to any one of the embodiments.

The rubber composition in accordance with the invention may also contain coupling activators, agents for covering the silica or more generally processing aids capable, in a known manner, by virtue of an improvement in the dispersion of the filler in the elastomer matrix and of a lowering of the viscosity of the rubber composition, of improving its ease of processing in the uncured state, these agents being, for example, hydrolysable silanes, such as alkylalkoxysilanes, polyols, polyethers, or hydroxylated or hydrolysable polyorganosiloxanes.

The rubber composition in accordance with the invention may also comprise all or some of the usual additives customarily used in rubber compositions intended for the manufacture of tyres, such as, for example, plasticizers, pigments, protective agents such as antiozone waxes, chemical antiozonants, antioxidants, antifatigue agents and mixtures of such compounds.

The rubber composition in accordance with the invention may be manufactured in appropriate mixers, generally using two successive phases of preparation well known to those skilled in the art: a first phase of thermomechanical working or kneading (“non-productive” phase) at high temperature, up to a maximum temperature of between 110 °C and 190 °C, preferably between 120 °C and 180 °C, followed by a second phase of mechanical working (“productive” phase) down to a lower temperature, typically of less than 110 °C, for example between 40 °C and 100 °C, during which finishing phase the crosslinking system is incorporated.

The rubber composition in accordance with the invention may be prepared according to a process which comprises the following steps:
thermomechanically kneading the elastomer matrix, the reinforcing filler, the coupling agent, and the other additives of the rubber composition with the exception of the crosslinking system, until a maximum temperature of between 110 °C and 190 °C is reached;
cooling the combined mixture to a temperature of less than 100 °C;
subsequently incorporating the crosslinking system;
kneading everything up to a maximum temperature of less than 110 °C, in order to obtain a rubber composition.

After incorporating all the ingredients of the rubber composition, the final composition thus obtained is then calendered, for example in the form of a sheet or a slab, in particular for laboratory characterization, or else extruded, in order to form, for example, a rubber profiled element that is used as rubber component or semi-finished product, in particular for the manufacture of a tyre. The rubber composition in accordance with the invention may be used in the form of a calendered product in a tyre. The calendered product or the extrudate formed from the rubber composition wholly or partly forms a semi-finished product, in particular of a tyre.

Thus, according to a particular embodiment of the invention, the rubber composition in accordance with the invention, which may either be in the uncured state (before crosslinking or vulcanization) or in the cured state (after crosslinking or vulcanization), is in a tyre, for example in a tyre tread.

The crosslinking (or curing), if applicable the vulcanization, is carried out in a known way at a temperature generally of between 130 °C and 200 °C, for a sufficient time which may vary, for example, between 5 and 120 min as a function in particular of the curing temperature, of the crosslinking system adopted and of the kinetics of crosslinking of the composition under consideration.

The semi-finished product in accordance with the invention has the essential feature of consisting wholly or partly of the rubber composition in accordance with the invention. It may be manufactured according to the process described above comprising an additional step of calendering or extruding the rubber composition. It is preferentially a tyre tread.

The invention also relates to the tread described above, both in the uncured state (that is to say, before curing) and in the cured state (that is to say, after crosslinking or vulcanization).

The invention also relates to the tyre comprising a rubber composition or a semi-finished product in accordance with the invention, which tyre is either in the uncured state or in the cured state, the semi-finished product preferably being a tread. In the present invention, a “tyre” is understood to mean a pneumatic or non-pneumatic tyre. A pneumatic tyre usually comprises two beads intended to come into contact with a rim, a crown composed of at least one crown reinforcement and a tread, and two sidewalls, the tyre being reinforced by a carcass reinforcement anchored in the two beads. A non-pneumatic tyre, for its part, usually comprises a base, designed for example for mounting on a rigid rim, a crown reinforcement ensuring the connection with a tread, and a deformable structure, such as spokes, ribs or cells, this structure being arranged between the base and the crown. Such non-pneumatic tyres do not necessarily comprise a sidewall. Non-pneumatic tyres are described, for example, in the documents WO 03/018332 and FR2898077. According to any one of the embodiments of the invention, the tyre according to the invention is preferentially a pneumatic tyre.

The abovementioned features of the present invention, and also others, will be better understood on reading the following description of several exemplary embodiments of the invention, which are given by way of nonlimiting illustration.

### EXAMPLES

### I. Measurements and Tests Used

### I.1 Determination of the Glass Transition Temperature of the Elastomers

The glass transition temperatures Tg and glass transition widths ΔTg of the polymers are measured by means of a differential calorimeter (differential scanning calorimeter) according to the standard ASTM D3418-08.

### I.2. Determination of the Microstructure of the Elastomers by NMR (Nuclear Magnetic Resonance) Analysis

The determination of the content of methacrylate units is carried out by ¹H NMR analysis. The spectra are acquired on a BRUKER Avance 500 MHz spectrometer equipped with a BBFO z-grad 5 mm “broad band” cryoprobe for the soluble samples and with an HRMAS 4 mm ¹H/¹³C probe for the insoluble crosslinked samples.

The quantitative ¹H NMR experiment uses a 30° single pulse sequence and a repetition time of 5 seconds between each acquisition. The samples are dissolved in deuterated chloroform.

The chemical shifts are calibrated with respect to the protonated impurity of the chloroform with respect to tetramethylsilane, TMS (8 ppm 1H at 0 ppm).

Assignment of the 1H NMR signals used for quantification in the butadiene/alkyl methacrylate copolymers:

| | Number of | |
|---|---|---|
| δ ¹H (ppm) | protons | Assignment |
| 3.3-4.4 | 2 | CH₂—O at the alpha position of the |
| | | ester group of the alkyl methacrylate units |
| 4.4-5.0 | 2 | Ethylenic CH₂ of the 1,2- (vinyl) |
| | | units of the butadiene part |
| 5.0-5.9 | 1 + 2 | Ethylenic CH of the 1,2- unit of the butadiene |
| | | part and 2 ethylenic CH of the 1,4- unit of |
| | | the butadiene part |

### I.3 Determination of the Macrostructure of the Elastomers by SEC Analysis

The SEC (Size Exclusion Chromatography) technique is used, which makes it possible to separate macromolecules in solution according to their size through columns filled with a porous gel. The macromolecules are separated according to their hydrodynamic volume, the bulkiest being eluted first.

SEC (PS calibration): SEC is coupled to a refractometer; it gives, in this case, relative information. Starting from commercial standard products, the various number-average molar masses (Mₙ) and weight-average molar masses (M_{w}) that characterize the distribution of the molar masses of the polymer may be determined and the polydispersity index (PDI=M_{w}/Mₙ) calculated via a Moore calibration. There is no particular treatment of the polymer sample before analysis. The latter is simply dissolved in the elution solvent at a concentration of approximately 1 g/l. The solution is then filtered through a filter with a porosity of 0.45 μm before injection.

The apparatus used is a Waters Alliance chromatographic line. The elution solvent is tetrahydrofuran, the flow rate is 1 ml/min, the temperature of the system is 35 °C and the analysis time is 45 min. A set of three Agilent (Mixed BLS) columns is used. The volume of the solution of polymer sample injected is 100 μl. The detector is a Waters 2414 differential refractometer and the software for processing the chromatographic data is the Waters Empower system.

The calculated average molar masses are relative to a calibration curve produced from “PSS Ready Cal-Kit” commercial polystyrene standards.

### I.4 Determination of the Coefficient of Friction

The coefficient of friction was measured on a test specimen and is listed in the table of the examples under the designation “μ laboratory”.

The measurements of coefficient of dynamic friction were carried out according to a method identical to that described by L. Busse, A. Le Gal and M. Küppel (Modelling of Dry and Wet Friction of Silica Filled Elastomers on Self-Affine Road Surfaces, Elastomer Friction, 2010, 51, p. 8). The test specimens were produced by moulding and then crosslinking of a square rubber support (50 mm×50 mm) having a thickness of 6 mm. After closing the mould, the latter is placed in a press comprising heated platens under a pressure of 16 bar, at a temperature (typically 150 °C) and for a time (typically several tens of minutes) necessary for the crosslinking of the material. The ground used to carry out these measurements is a core withdrawn from a real road surface made of bituminous concrete of BBTM [very thin bituminous concrete] type (standard NF P 98-137). In order to prevent the phenomena of dewetting and the appearance of secondary grip forces between the ground and the material, the ground+test specimen system is immersed in a 5% aqueous solution of a surfactant (Sinnozon—CAS number: 25155-30-0). The temperature of the aqueous solution is regulated using a thermostatically controlled bath.

The test specimen is subjected to a sliding movement in translation parallel to the plane of the ground. The sliding velocity Sv is set at 1.2 m/sec. The normal stress applied σₙ is 300 kPa. These conditions are described below by “wet ground conditions”. The tangential stress σₜ, opposed to the movement of the test specimen over the ground, is measured continuously. The ratio of the tangential stress σₜ to the normal stress σₙ gives the coefficient of dynamic friction μ. The values of μ are measured for an aqueous solution temperature of 5 °C to 45 °C, and are obtained under steady state conditions after stabilization of the value of the tangential stress σt.

The maximum of the coefficient of dynamic friction over the range of aqueous solution temperature of from 5 to 45 °C (denoted “μ laboratory max” in the table of the examples) is a relevant descriptor of the intrinsic grip performance on wet ground of the rubber composition tested. With the results being expressed in base 100, a value above that of the reference, arbitrarily set at 100, indicates an improved result.

### I.5 Determination of the Loss Factor

The dynamic properties tan δ max are measured on a viscosity analyser (Metravib VA4000) according to the standard ASTM D 5992-96. The response of a sample of vulcanized composition (cylindrical test specimen with a thickness of 4 mm and a cross section of 400 mm²), subjected to a simple alternating sinusoidal shear stress, at a frequency of 10 Hz, under standard temperature conditions (23 °C) according to the standard ASTM D 1349-99, is recorded. A strain amplitude sweep is performed from 0.1% to 100% (outward cycle) and then from 100% to 0.1% (return cycle). The result made use of is the loss factor tan δ between the values at 0.1% and 100% strain (Payne effect). For the return cycle, the maximum value of tan δ observed, denoted tan δ max return, is indicated.

The tan δ max return is a descriptor of the intrinsic rolling resistance performance of the rubber composition tested. With the results being expressed in base 100, a value below that of the reference, arbitrarily set at 100, indicates an improved result (lower rolling resistance).

### I.6 Determination of the Reinforcement on a Force-Elongation Curve

The tensile tests are carried out in accordance with the French standard NF T 46-002 of September 1988. The nominal secant modulus (or apparent stress) in MPa, calculated by normalizing to the initial cross section of the test specimen, in MPa, is measured at 100% elongation, denoted MA100, and at 250% elongation, denoted MA250.

All of these tensile measurements are carried out under the standard conditions of temperature (23+/−2 °C) and hygrometry (50+/−5% relative humidity), according to the French standard NF T 40-101 (December 1979).

The ratio between the modulus of stiffness under tension at 250% elongation and the modulus of stiffness under tension at 100% elongation, hereinafter denoted MA250/MA100, is a descriptor of the reinforcement of the rubber composition tested at high strains. With the results being expressed in base 100, a value above that of the reference, arbitrarily set at 100, indicates an improved result.

### II Preparation of the Elastomers

The elastomers used for the examples are prepared as follows:

Synthesis of the Copolymer of 1,3-butadiene and 2-ethylhexyl methacrylate (Elastomer 1):

The reaction takes place in a 100-litre reactor. 0.7 kg (0.5 phr) of sodium dodecyl sulfate (SDS) are dissolved in 15 litres of demineralized water. 6.29 g of cumene hydroperoxide (0.05 equivalent of transfer agent with respect to the SDS), 2.5 kg of 1,3-butadiene and 3 kg of n-butyl methacrylate are added to the reaction medium. The reactor is heated to 5 °C with a stirring speed of 80 rpm, before introducing 0.23 kg (1.2 phr) of potassium persulfate. After 410 minutes of polymerization reaction, 62% conversion of monomers to copolymer is achieved. The reaction is then stopped by addition of 0.67 kg (3 phr) of resorcinol. The latex is then coagulated in two volumes of an acetone/ethanol mixture. The copolymer is then dried in an oven at 45 °C. 3.4 kg of copolymer of 1,3-butadiene and 2-ethylhexyl methacrylate are recovered with a content of volatile matter of less than 1%.

Synthesis of the Copolymer of 1,3-butadiene and n-butyl methacrylate (Elastomer 2):

The reaction takes place in a 10-litre reactor. 67 g (5 phr) of sodium stearate are dissolved in 2.56 litres of demineralized water. 1 g of tert-dodecyl mercaptan (0.05 equivalent of transfer agent with respect to the potassium persulfate), 369 g of 1,3-butadiene and 990.5 g of n-butyl methacrylate are added to the reaction medium. The reactor is heated to 50 °C and stirring is started. 25.6 g (1.2 phr) of potassium persulfate in solution in 789 ml of water are then added. After 80 minutes of polymerization reaction, 60% conversion of monomers to copolymer is achieved. The reaction is then stopped by adding 27.5 g of resorcinol (2.6 equivalents of resorcinol with respect to the potassium persulfate) in solution in 789 ml of water. The latex is then coagulated in two volumes of an acetone/ethanol mixture. The copolymer is then dried in an oven at 45 °C. 0.74 kg of copolymer of butadiene and n-butyl methacrylate are recovered with a content of volatile matter of less than 1%.

The copolymers obtained possess the following characteristics:

For the elastomer 1 (copolymer of 1,3-butadiene and 2-ethylhexyl methacrylate):
Tg=−53 °C and ΔTg=8 °C.
Mn=238 000 g/mol (PS calibration) and PDI=2.5
molar % (2-ethylhexyl methacrylate monomer unit)=43.9
molar % (butadiene monomer unit)=56.1

For the elastomer 2 (copolymer of 1,3-butadiene and n-butyl methacrylate):
Tg=−46 °C and ΔTg=7 °C.
Mn=356 000 g/mol (PS calibration) and PDI=3.4
molar % (n-butyl methacrylate monomer unit)=44.4
molar % (butadiene monomer unit)=55.6

### III Preparation of the Rubber Compositions

Two rubber compositions C1 and C2 are prepared. The formulations (in phr) of the compositions C1 and C2 are described in Table 1.

The composition C2 is in accordance with the invention; the composition C1 is not in accordance with the invention.

The compositions C1 and C2 also both contain a reinforcing filler, in the case in point, a silica.

The compositions C1 and C2 both contain an elastomer, a random copolymer comprising monomer units of a 1,3-diene (in the case in point, monomer units of 1,3-butadiene) and monomer units of an ester of methacrylic acid (an alkyl methacrylate), the monomer units of the ester of methacrylic acid representing at least 30 mol % (in the case in point, 44 mol % for elastomer 1 in C1, and 44 mol % for elastomer 2 in C2) of the monomer units of the elastomer. In the composition C1, not in accordance with the invention, the alkyl group is 2-ethylhexyl (a C₈ alkyl group), the methacrylate being 2-ethylhexyl methacrylate (hereinafter denoted EHMA). In the composition C2, in accordance with the invention, the alkyl group is n-butyl (a C₄ alkyl group), the methacrylate being n-butyl methacrylate (hereinafter denoted BuMA).

The crosslinking systems of the compositions C1 and C2 are vulcanization systems.

These compositions are manufactured in the following way: the elastomer, the silica, the coupling agent, the plasticizer and also the various other ingredients, with the exception of the crosslinking system, are successively introduced into an internal mixer (final degree of filling: approximately 70% by volume), the initial vessel temperature of which is approximately 60 °C. Thermomechanical working (non-productive phase) is then carried out in one step, which lasts in total 5 min, until a maximum “dropping” temperature of 165 °C is reached.

The mixture thus obtained is recovered and cooled and then the crosslinking system is incorporated on a mixer (homofinisher) at 23 °C, everything being mixed (productive phase) for an appropriate time (for example between 5 and 12 min).

The compositions thus obtained are subsequently calendered in the form of slabs (with a thickness ranging from 2 to 3 mm) or thin sheets of rubber, for the measurement of their physical properties after vulcanization at 170 °C for 30 min.

### IV Properties of the Rubber Compositions

The properties of the compositions C1 and C2 are given in base 100 with respect to C1 in Table 2.

The composition C2, in accordance with the invention, has a maximum tan δ return at 23 °C and 10 Hz very close to that of the composition C1 (97 vs 100), allowing a prediction of a similar rolling resistance performance between a tyre for which the composition C2 is used as tread and a tyre for which the composition C1 is used as tread.

Moreover, the composition C2, in accordance with the invention, has a maximum laboratory μ at 3 bar and 1.2 m/s very close to that of the composition C1 (98 vs 100), allowing a prediction of a similar grip performance on wet ground between a tyre for which the composition C2 is used as tread and a tyre for which the composition C1 is used as tread.

Furthermore, the composition C2, in accordance with the invention, has an MA250/MA100 ratio that is markedly improved compared to the composition C1 (113 vs 100), allowing a prediction of a reinforcement and a wear and attack resistance performance that are markedly greater for a tyre for which the composition C2 is used as tread than for a tyre for which the composition C1 is used as tread.

The results obtained thus show that the composition in accordance with the invention indeed makes it possible in this instance to solve the technical problem in that it results in an improved reinforcement while retaining a good compromise between the rolling resistance and the grip on wet ground.

TABLE 1

| | C1 | C2 |
|---|---|---|
| Elastomer 1 (1) | 100 | — |
| Elastomer 2 (2) | | 100 |
| Silica (3) | 86.1 | 86.1 |
| Silane Si69 (4) | 8.9 | 8.9 |
| Plasticizer (5) | 31.4 | 31.4 |
| DPG (6) | 1.5 | 1.5 |
| Antioxidant (7) | 1.9 | 1.9 |
| Stearic acid | 2 | 2 |
| ZnO (8) | 3 | 3 |
| Sulfur | 1.5 | 1.5 |
| Sulfenamide (9) | 1.5 | 1.5 |

(1) Copolymer of 1,3-butadiene and 2-ethylhexyl methacrylate (see section II.)
(2) Copolymer of 1,3-butadiene and n-butyl methacrylate (see section II.)
(3) Zeosil 1165 MP silica from Solvay-Rhodia, in the form of microbeads
(4) Triethoxysilylpropyl tetrasulfide (TESPT) liquid silane, Si69, from Evonik
(5) Trioctyl phosphate (tri-2-ethylhexyl phosphate), Disflamoll TOF, from Lanxess
(6) Diphenylguanidine (Perkacit DPG from Flexsys)
(7) N-(1,3-Dimethylbutyl)-N′-phenyl-p-phenylenediamine (6PPD from Flexsys)
(8) ZnO, zinc oxide of industrial grade from Umicore
(9) N-Cyclohexyl-2-benzothiazolesulfenamide (Santocure CBS from Flexsys)

TABLE 2

| | C1 | C2 |
|---|---|---|
| tan δ max return 23 °C 10 Hz | 100 | 97 |
| μ laboratory max 3 bar 1.2 m/s | 100 | 98 |
| MA250/MA100 23 °C | 100 | 113 |

1.-12. (canceled)

13. A rubber composition comprising:
a reinforcing filler;
a crosslinking system; and
an elastomer A, which is a random copolymer comprising monomer units of a 1,3-diene and monomer units of an ester of methacrylic acid corresponding to the formula CH₂═CMe-COOR¹,
in which Me is a methyl group and R¹ is a C₄ alkyl group, and
the monomer units of the ester of methacrylic acid represent at least 30 mol % of the monomer units of the elastomer A.

14. The rubber composition according to claim 13, wherein R¹ is a linear alkyl group.

15. The rubber composition according to claim 13, wherein the monomer units of the ester of methacrylic acid represent at least 40 mol % of the monomer units of the elastomer A.

16. The rubber composition according to claim 13, wherein the monomer units of the ester of methacrylic acid represent at most 90 mol % of the monomer units of the elastomer A.

17. The rubber composition according to claim 13, wherein the elastomer A is a copolymer of the 1,3-diene and the ester of methacrylic acid.

18. The rubber composition according to claim 13, wherein the 1,3-diene is 1,3-butadiene or isoprene or a mixture of 1,3-butadiene and isoprene.

19. The rubber composition according to claim 13, wherein the reinforcing filler comprises a silica.

20. The rubber composition according to claim 19, wherein the silica represents more than 50% by mass of the reinforcing filler.

21. The rubber composition according to claim 13, wherein the crosslinking system is a vulcanization system.

22. A semi-finished product comprising the rubber composition according to claim 13.

23. The semi-finished product according to claim 22, wherein the semi-finished product is a tire tread.

24. A tire comprising the semi-finished product according to claim 22.

25. A tire comprising the rubber composition according to claim 13.
